(19) United States
(12) Patent Application Publication
(10) Pub. No.: US 2004/0037978 A1
(43) Pub. Date: Feb. 26, 2004

(54) Ink jet recording sheet and a preparation method thereof

(75) Inventors: Yoshinori Tsubaki, Tokyo (JP); Masayuki Ushiku, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/643,394

(22) Filed: Aug. 18, 2003

(30) Foreign Application Priority Data
Aug. 20, 2002 (JP) JP2002-239068
Jul. 10, 2003 (JP) JP2003-194811

(51) Int. Cl. B41M 5/00

(52) U.S. Cl. 428/32.26

(57) ABSTRACT

An ink-jet recording sheet is disclosed. The sheet has a porous layer containing fine particles and a binder containing a polymer compound crosslinked through side chains of the polymer on a support, in which the crosslinked polymer compound is formed by irradiating ionizing radiation to a hydrophilic polymer compound having a polymerization degree of not less than 300 and a plurility of side chain on main chain of the hydrophilic polymer compound.

### BACKGROUND OF THE INVENTION

The present invention relates to an ink jet recording sheet (hereinafter also simply referred to as a recording sheet), and more specifically to an ink jet recording sheet comprising a porous layer which minimizes cracking and results in enhancement of layer strength.

In recent years, in ink jet recording systems, image quality has increasingly been improved and is approaching that of conventional silver salt photography. As a means to achieve such conventional photographic quality employing ink jet recording, recording sheets used for ink jet recording have been subjected to rapid technical improvements.

An ink jet recording sheet has been invented which, for example, comprises a highly smoothed support having thereon an ink absorptive layer which is formed by applying hydrophilic binders such as gelatin and PVA onto the aforesaid support. In such a type of recording sheet, ink is absorbed due to swellability of the binders. Since the aforesaid ink receiving layer is comprised of water-soluble resins, problems have occurred in which after printing, ink is not dried as desired, and desired water resistance is not achieved due to the fact that images and layers are not sufficiently resistant to water. Further, since the printing speed of current ink jet printers is much enhanced, ink absorption achieved by swelling of binders does not catch up to the ejected ink amount and ink injection rate. As a result, the aforesaid ink jet sheet has been found to be unsuitable for current ink jet printers due to problems such as ink flooding and nottling.

Further, Japanese Patent Application Open to Public Inspection (JP O. P. I) No. 1-286886 discloses an aqueous ink recording sheet comprising a receiving layer comprised of a hydrophilic resin which undergoes crosslinking employing ionizing radiation. In the aforesaid invention, the water resistance of images and layers is enhanced as desired by employing an ink receiving layer comprised of cured binders. However, since originally, ink absorption was achieved through swelling of resins, the aforesaid ink absorption is not enhanced but decreases.

Contrary to the aforesaid ink jet recording sheets which absorb ink utilizing swellability of water-soluble resins, Japanese Patent Application Open to Public Inspection No. 10-119423 discloses a recording sheet comprised of a porous layer having minute voids. Such a recording sheet exhibits sufficient ink absorbability as well as sufficient drying capability. The use of the aforesaid recording sheet is becoming one of the methods which produces prints exhibiting image quality closest to conventional photography.

The aforesaid porous layer is comprised mainly of hydrophilic binders and fine particles. Known as fine particles are fine inorganic or organic particles.

By employing hydrophilic binders in a relatively small amount together with such fine inorganic particles, voids are formed among the aforesaid fine particles, whereby a porous layer at a high void ratio is prepared.

Through the formation of such voids, ink is absorbed utilizing capillary action. As a result, even though water resistance is enhanced by crosslinking binders employing crosslinking agents, the ink absorption rate is not adversely affected.

Since the aforesaid porous layer is comprised of fine inorganic particles as a major component, the resulting layer is originally a hard layer. When such a thick porous layer is applied onto a non-water absorptive support, cracking tends to occur during its drying.

Further, the addition of additives, which provide liquid coating composition for forming a porous layer with several functions, seals voids, resulting in a tendency to decrease the void ratio.

Still further, during the production process of a porous layer, the porous layer is formed as follows. The surface of fine particles is covered with a small amount of hydrophilic binder and further the hydrophilic binders intertwine with each other, resulting in retention of fine particles, whereby the porous layer is formed while forming a protective colloid. During this process, the presence of additives, especially those such as water-soluble multivalent metal compounds prevents hydrophilic binders from being intertwined with each other and allows fine inorganic particles to aggregate whereby the strength of the resulting layer decreases.

As a result, it is assumed that during contraction of the resulting layer, especially during final drying of the layer, the strength-lowered layer tends to result in cracking.

In order to prepare a desired layer surface which does not suffer from cracking and the like, it has been essential to achieve drying under relatively mild conditions while lowering productivity.

On the other hand, in an absorptive layer after drying, fine particles are bound only utilizing a relatively small amount of hydrophilic binders, whereby problems have occurred in which the resulting water resistance degraded. In order to overcome the aforesaid problems, an ink jet recording sheet has been invented in which layer water resistance is enhanced employing hydrophilic binder crosslinking agents such as boric acid. Such crosslinking agents result in three-dimensional crosslinking within a relatively short distance. As a result, even though water resistance of the dried layer is enhanced, new problems have found in which the layer more easily cracks when folded. Specifically, the aforesaid problems are pronounced for layers in which the weight ratio of fine particles to binders is at most ⅕. A binder such as gelatin and polyvinyl alcohol is employed in the ink absorbing layer. The binder is gelated or increased in the viscosity by cooling in the case of gelatin, or addition of a crosslink forming agent such as a boron compound for polyvinyl alcohol to prevent roughening by the blowing, flowing and nottling of the coated layer in the drying process for forming a uniform layer. In the case of gelatin, gelatin is gelated by cooling and in the case of polyvinyl alcohol, a boron compound is added. Thus formed crosslinking is held after dried and the layer having a high humid resistively. When gelatin is employed, the uniform layer can be obtained by gelation of gelatin at a low temperature to inhibit the fluid of the coated layer. However, in such the case, there is a problem that a long time necessary for drying since the layer should be dried at the low temperature with the fluid of the coated layer is lost.

On the other hand, Japanese Patent Publication Open to Public Inspection, hereinafter referred to as JP O.P.I. Publication, No. 9-263038 can be referred as an example of applying an ink accepting layer containing a hydrophilic resin crosslinked by ionizing radiation for a porous type ink-jet recording sheet having a porous layer including pores. JP O.P.I. Publication proposes a method for forming an ink accept layer in which a coating composition mainly comprised of an inorganic sol and a monomer/oligomer hardenable by ionizing radiation is coated and the monomer/oligomer hardenable by ionizing radiation is hardened by irradiation of the ionizing radiation and then the coated layer is dried.

However, the coated layer which is constituted by relatively high density and three dimensional linkages employing ethylenic double bonds is hard and brittle and the resistively to breaking of the layer is low.

The monomers/oligomers hardenable by ionizing radiation generally have relatively low molecular weight and include many ones showing strong skin stimulation. Moreover, unreacted free radical, a polymerization initiator or a polymerization inhibitor remained in the coated layer breaks or decomposes polymer chain so that the breaking of the coated layer is degraded in the storing period.

Furthermore, almost the monomers/oligomers hardenable by ionizing radiation available on the market has low hydrophilicity which are unsuitable for the general coating employing an aqueous system coating composition as the method of forming the ink accepting layer of the ink-jet recording sheet. Accordingly, a problem is raised that the allowance of selection range of the materials is extremely narrow.

### SUMMARY OF THE INVENTION

Accordingly, a first object of the present invention is to provide an ink jet recording sheet having a support and a porous layer comprising hydrophilic binders and fine particles as well as a preparation method thereof, which suffers negligibly from cracking during production and which results in, after production, high durability against folding and bending, a high void ratio, high ink absorbability and high bleeding resistance.

A second object of the present invention is to provide the ink jet recording sheet as well as the preparation method thereof, which has high water resistance and bleeding resistance in addition to the first object.

The present invention was achieved employing the embodiments below.

1. An ink-jet recording sheet comprising; a support; and a porous layer including fine particles and a binder containing a polymer compound crosslinked through side chains of the polymer on the support, wherein the crosslinked polymer compound is formed the crosslink by irradiating ionizing radiation to a hydrophilic polymer compound which has a polymerization degree of not less than 300 and a plurality of side chains on a main chain of the hydrophilic polymer compound.

2. The ink jet recording sheet, described in 1. above, wherein a weight ratio of the fine particles to the binder in the porous layer is from 2:1 to 50:1.

3. The ink jet recording sheet, described in 1. above, wherein the weight ratio of the fine particles to the binder in the porous layer is from 6:1 to 15:1.

4. The ink jet recording sheet, described in any one of 1. to 3. above, wherein the porous layer includes a multivalent metal compound.

5. The ink jet recording sheet, described in any one of 1. to 4. above, wherein the diameter of fine particles is from 0.005 to 0.4 μm.

6. The ink-jet recording sheet described in any one of 1 to 5, wherein the hydrophilic polymer has a photosensitive group capable of dimerization on the side chains by the ionizing radiation.

7. A producing method of an ink-jet recording sheet comprising the step of:

providing on a support a layer including fine particles and a binder containing hydrophilic polymer compound which has plural side chains on the main chain thereof and a polymerization degree of not less than 300; and

irradiating ionized radiation to the polymer compound to form crosslinking through the side chains to form a porous layer.

8. The producing method of an ink-jet recording sheet described in 7, wherein the weight ratio of the fine particles to the binder containing the polymer compound formed by the crosslinking through the side chains is from 2:1 to 50:1.

9. The producing method of an ink-jet recording sheet described in 7, wherein the weight ratio of the fine particles to the binder containing the polymer compound formed by the crosslinking through the side chains is from 6:1 to 15:1.

10. The producing method of an ink-jet recording sheet described in any one of 7 to 9, wherein the porous layer contains a multivalent metal compound.

11. The producing method of an ink-jet recording sheet described in any one of 7 to 10, wherein the diameter of the fine particle is from 0.005 μm to 0.4 μm.

12. The producing method of an ink-jet recording sheet described in any one of 7 to 11, wherein the hydrophilic polymer has a photosensitive group capable of dimerization by the ionizing radiation on the side chains.

13. The producing method of an ink-jet recording sheet described in any one of 7 to 12, wherein the porous layer is formed by coating a coating composition comprising the fine particle and the hydrophilic polymer compound which has plural side chains on the main chain thereof and a polymerization degree of not less than 300, and irradiating an ionizing radiation to the polymer compound in the coated layer to form the crosslink through the side chains.

14. The producing method of an ink-jet recording sheet described in 13, wherein the irradiation of the ionizing radiation is applied at a time in which the weight ratio of solvent to the solid component in the coated layer is not less than 100%.

15. The producing method of an ink-jet recording sheet described in any one of 13 and 14, wherein the polymer compound in the coated layer is irradiated by the ionizing radiation so that the elastic modulus of the coated layer after the irradiation is not less than 1.5 times of that of the coated layer before the irradiation and the viscosity coefficient of the coated layer after the irradiation is not less than 1.5 times of that of the coated layer before the irradiation.

16. The producing method of an ink-jet recording sheet described in 14, wherein the irradiation of the ionizing radiation is further applied at a time in which the weight ratio of water to the solid component in the coated layer is less than 100%.

17. The producing method of an ink-jet recording sheet described in any one of 13 to 16, wherein the coated layer is dried after the irradiation in atmosphere at a temperature higher not less than 10° C. than that before the irradiation.

18. The producing method of an ink-jet recording sheet described in any one of 13 to 17, wherein the dried coated layer is stood for not less than 24 hours in atmosphere at a temperature of not less than 30° C.

19. The producing method of an ink-jet recording sheet described in any one of 7 to 18, wherein the ionizing radiation is ultraviolet ray.

### DETAILED DESCRIPTION OF THE INVENTION

The inventors of the present invention conducted investigations to overcome the aforesaid various problems. As a result, by employing the aforesaid means, the following was discovered. By employing binders at reduced amount, it was possible to obtain and produce, at high productivity, a high quality porous layer which exhibited a high void ratio as well as high ink absorption efficiency, while minimizing cracking. Further, it was also discovered that by employing the aforesaid means, it was possible to obtain and produce an ink jet recording sheet which exhibited higher durability against bending and the like, and outdoor resistance.

The present invention is described in detail below.

The ink-jet recording sheet according to the invention has a porous layer containing fine particles and a binder including the polymer compound crosslinked through the side chains as the binder on a support. The crosslinked polymer compound is crosslinked through the side chains with each other by irradiating ionizing radiation to hydrophilic polymer having a polymerization degree of not less than 300 and a plurality of side chain on the main chain thereof.

The term “polymer compound is crosslinked through side chains” means that the polymer compound is crosslinked between side chains or among the side chains.

The porous layer is a layer having a volume of the void of from 15 to 40 ml/m². The volume of the void is defined by the amount of transferred liquid at the contacting time of 2 seconds according to “Measurement Method Liquid Absorbability of Paper and Cardboard” (Bristow method) defined in J. TAPPI 51.

The ink can be temporarily held in the porous layer on the occasion of the recording when the dried thickness of the porous layer is preferably not less than 25 μm, and is more preferably from 30 μm to 50 μm.

In the invention, the polymer compound crosslinked through the side chains is a polymer compound crosslinked through the side chains with each other by irradiating the ionizing radiation to the hydrophilic polymer compound having a polymerization degree of not less than 300 and the side chains on the main chain thereof.

In the invention, the hydrophilic polymer compound having the plural side chains on the main chain thereof and a polymerization degree of not less than 300 is a polymer compound which has a polymerization degree of not less than 300 and is capable of crosslinking through the side chains by irradiation of the ionizing radiation. The main chain of the polymer compound is constituted by at least one selected from the group consisting of (a) saponification product of vinyl acetate, (b) polyvinyl acetal, (c) polyethylene oxide, (d) polyalkylene oxide, (e) polyvinylpyrrolidone, (f) polyacrylamide, (g) hydroxyethyl cellulose, (h) methyl cellulose, (i) hydroxypropyl cellulose, (j) at least one derivative of (a) through (i), and (k) a copolymer containing two or more of (a) through (j).

These polymer compounds are preferably resin capable of converting more water insoluble after crosslinking by the irradiation of the ionizing radiation such as ultraviolet ray or electron lay than that before crosslinking.

The side chain is preferably constituted by a modifying group selected from the groups of photo-dimerizable type, photo-decomposable type, photo-polymerizable type, photo-modifying type and photo-demerizable type. Such the side chain is preferably formed by modifying the main chain of the at least one kind of the foregoing (a) through (k).

Any polymerization initiator and polymerization inhibitor are substantially not necessary for forming the crosslinking of the hydrophilic polymer compound having a polymerization degree of not less than 300 and plural side chains on the main chain thereof to be used in the invention, and the formation of unreacted free radical after the irradiation of the ionizing radiation can be also inhibited. Therefore, the degradation of the resistively against breaking (i.e. fissure by folding) occurrence accompanied with the passing of storage period can be inhibited.

The network structure of the porous layer according to the invention can be easily hold many fine particles since such the layer contains the binder containing the polymer compound formed by crosslinking through the side chains by irradiating the ionizing radiation to the hydrophilic polymer compound having plural side chains on the main chain thereof and a polymerization degree of not less than 300 which has a long distance crosslinkage different from the relatively short distance crosslinkage of the three dimensional structure in the porous network formed by crosslinking by only use of the polymerization initiator or that formed by crosslinking by the irradiation of the ionizing radiation to a hydrophilic polymer compound having no plural side chains or a polymer compound having a lower polymerization degree. Consequently, a uniform porous layer can be formed by a smaller amount of the binder namely by a smaller ratio of the binder to the amount of the fine particles.

The void ratio (i.e. the ratio of pore space) in the ink-jet recording layer can be raised and the ink is more easily held in the layers when the ratio of the binder to the fine particles is smaller. Accordingly, the overflow of the ink can be prevented. Thus the ink-jet recording sheet having a porous layer can be obtained, which can be rapidly dried and has high strength of the coated layer and high resistivity against folding. Furthermore, the porous layer has high resistivity against cracking and peeling off the layer and to stress caused by folding before and after printing of image.

Therefore, an ink-jet recording sheet can be obtained, which has high ink absorbability and improved resistively to water and inhibited occurrence of fissures caused by folding and cracks.

It is preferable that the hydrophilic polymer compound having the plurality of side chains on the main chain is photo-dimerizable diazo type compound or one introduced with a cinnamoyl group, a styrylpyridinium group or a styrylquinolinium group.

Further, it is preferable that the hydrophilic polymer is resin which are dyed with water-soluble dyes such as anionic dyes after photo-crosslinking. Listed as such resins are, for example, resins having a cationic group such as a primary amino group and a quaternary ammonium group, photosensitive resins (being compositions) described, for example, in Japanese Patent Application Open to Public Inspection Nos. 56-67309, 60-129742, 60-252341, 62-283339, and 1-198615, resins having a group such as an azido group which is converted to an amino group through a curing treatment, while becoming cationic, and photosensitive resins (being compositions) described, for example, in Japanese Patent Application Open to Public Inspection No. 56-67309.

Specifically listed are the following compounds.

In the present invention, preferably employed are photosensitive resins described in Japanese Patent Application Open to Public Inspection No. 56-67309. The aforesaid resins include resin compositions having a 2-azido-5-nitrophenylcarbonyloxyethylene structure represented by Formula (I), described below, or a 4-azido-3-nitrophenylcarbonyloxyethylene structure represented by Formula (II), also described below, in a polyvinyl alcohol structure.

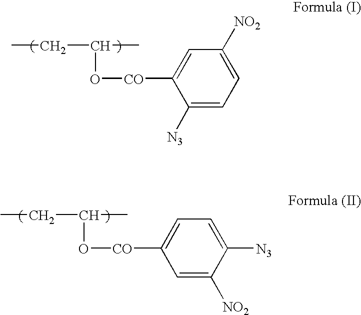

Specific examples of the aforesaid resins are described in Examples 1 and 2 of the aforesaid patent publication, while constitution components and their used ratio are described on page 2 thereof.

Further, Japanese Patent Application Open to Public Inspection No. 60-129742 describes photosensitive resins which include polyvinyl alcohol based resins having the structural units represented by Formula (III) or (IV), described below, in the polyvinyl alcohol structure;

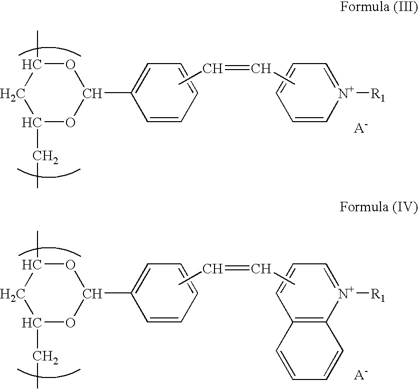

wherein R₁ represents an alkyl group having 1-4 carbon atoms, and A⁻ represents an anion. These are polyvinyl alcohol based resins having structural units comprising a styrylpyridinium (stilbazolium) structure or a styrylquinolinium structure, which are prepared by allowing polyvinyl alcohol or partially saponified polyvinyl acetate to react with a styrylpyridinium salt or a styrylquinolinium salt. The production method of these is described in Japanese Patent Application Open to Public Inspection No. 60-129742 and is easily produced with reference to the aforesaid patent publication.

The ratio of a styrylpyridinium group or a styrylquinolinium group in polyvinyl alcohol having the styrylpyridinium group or the styrylquinolinium group is preferably 0.2-10.0 mol percent per polyvinyl alcohol unit. The more photosensitive units are introduced, the higher the speed. When the aforesaid constitution units are introduced into polyvinyl alcohol in an amount within the upper limit, the resulting resins are easy to dissolve in water. On the other hand, when the ratio is more than to 0.2 percent, the effects of the present invention are achieved due to sufficient strength after crosslinking.

Further, in the foregoing, polyvinyl alcohol used as a main component may be comprised of acetyl groups which are not partially saponified and the proportion of the acetyl group is preferably less than 30 percent. The degree of polymerization thereof is preferably about 400- about 3,000, and a degree of polymerization of 400 or less is preferred because it is possible to inhibit deterioration of resistivity against folding due to the three dimensional structure density becoming high. Further, when the degree of polymerization is not more than 3,000, handling may be easy it is possible to inhibit a viscosity from becoming high.

The following hydrophilic resin may be used in the porous layer as the binder together with the polymer compound having the plural side chains on the main chain thereof and a polymerization degree of not less than 300 as long as such the resin does not degrade the properties of the object of the invention.

Hydrophilic binders additionally incorporated in the porous layer are not particularly limited, and any of those, may be employed. For example, employed may be gelatin, polyvinylpyrrolidone, polyethylene oxide, polyacrylamide, and polyvinyl alcohol. Of these, polyvinyl alcohol is particularly preferred.

Polyvinyl alcohol exhibits an interaction with fine inorganic particles so as to result in a high holding force of fine inorganic particles. Further, polyvinyl alcohol is a polymer whose hygroscopic properties exhibit a relatively small dependence on humidity, and whose contraction stress during coating and drying is also relatively small. As a result, polyvinyl alcohol is excellent in minimizing cracking during coating and drying, which is the problem to be solved by the present invention. Polyvinyl alcohol preferably employed in the present invention includes common polyvinyl alcohol which is prepared by hydrolyzing polyvinyl acetate and also modified polyvinyl alcohol such as polyvinyl alcohol whose terminals have been subjected to cation modification and anion-modified polyvinyl alcohol having an anionic group.

The average degree of polymerization of said polyvinyl alcohol prepared by hydrolyzing vinyl acetate is preferably at least 300, and is more preferably from 1,000 to 5,000. The saponification ratio of said polyvinyl alcohol is preferably from 70 to 100 percent, and is more preferably from 80 to 99.5 percent.

Said cation-modified polyvinyl alcohol includes, for example, polyvinyl alcohol which has a primary, secondary or tertiary amino group, or a quaternary ammonium group in the main or side chain of said polyvinyl alcohol, as described in Japanese Patent Publication Open to Public Inspection No. 61-10483. Said polyvinyl alcohol is prepared by saponifying the copolymer of an ethylenic unsaturated monomer having a cationic group and vinyl acetate.

The ratio of fine particles and the hydrophilic binders of the porous layer is preferably from 2:1 to 50:1 in terms of weight ratio. When said weight ratio is less than 2:1, the desired void ratio of the porous layer is obtained. As a result, it is possible to obtain the sufficient void volume easily. In addition, it is able to reduce that excessive hydrophilic binders swell during ink jet recording and block voids (i.e. the space of pores), becoming a factor in the decrease of the ink absorption rate. On the other hand, when said ratio is not more than 50:1, it is able to reduce that undesirable cracking tends to occur during coating a relatively thick porous layer. The ratio of fine particles and said hydrophilic binders is preferably from 6:1 to 15:1 in view of avoiding breaking of dried coat by folding.

In the invention, the fine particles form the space of pores in the porous layer together with the polymer compound formed by crosslinking through the side chains of the hydrophilic polymer compound having the plural side chains on the main chain thereof and a polymerization degree of not less than 300 by the irradiation of the ionizing radiation. As the fine particle to be contained in the porous layer, inorganic particles are preferably used since further small particle can be easily obtained, and the recording paper with high glossiness and a high density printed image can be obtained even though an organic particle may also be used.

Employed as fine particles usable in the present invention may be fine inorganic and organic particles. However, fine inorganic particles are particularly preferred, since high gloss as well as high color density is obtained, and in addition, fine particles are easily prepared. Listed as said inorganic particles may be, for example, white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, and magnesium hydroxide. Primary particles of said fine inorganic particles may be employed without any further modification, and said inorganic particles may also be employed in the state in which secondary coagulated particles are formed.

In the present invention, from the viewpoint of preparing high quality prints utilizing ink jet recording sheets, preferred as fine inorganic particles are alumina, pseudo-boehmite, colloidal silica, and fine silica particles synthesized employing a gas phase method. Of these, fine silica particles synthesized employing a gas phase method are particularly preferred. Said silica synthesized employing a gas phase method, whose surface is modified with aluminum may be employed. The content ratio of aluminum in the gas phase method silica whose surface is modified with aluminum is preferably from 0.05 to 5 percent by weight with respect to the total silica.

When the organic particle is used in the porous layer as the fine particle, a fine particle is preferably used, which is obtained by emulsion polymerization of a monomer selected from the group consisting of an alkyl acrylate, an alkyl methacrylate, styrene and a styrene derivative using a emulsifying agent having one or more carbon-carbon double bonds in the molecule thereof.

The diameter of said fine particles in the porous layer is not particularly limited, however, the average diameter is preferably not more than 4 μm. When said diameter is preferably not more than 4 μm, the good glossiness as well as color forming properties are resulted. Therefore, said diameter is more preferably no more than 0.2 μm, and is most preferably no more than 0.1 μm. The lower limit of said diameter is not particularly limited, however, from the viewpoint of producing said fine particles, said lower limit is preferably not less than approximately 0.003 μm, and is more preferably not less than 0.005 μm.

The average diameter of said fine particles is obtained as follows. The cross-section and surface of a porous layer are observed employing an electron microscope, and the diameter of 100 randomly selected particles is determined. Then, said average diameter is obtained as a simple average (being a number average), based on the obtained data. Herein, each particle diameter is the diameter of the circle which has the same area as the projection area of each particle.

Further, from the viewpoint of glossiness as well as color forming properties, the degree of dispersion of fine particles in the porous layer is preferably no more than 0.5. When said degree of dispersion is not more than 0.5, the resulting glossiness as well as color forming properties of the image printed is sufficiently obtained. Said degree of dispersion is most preferably no more than 0.3. The degree of dispersion of fine particles, as described herein, refers to the value obtained by dividing the standard deviation of the particle diameter by the average particle diameter which is determined by observing the fine particles of the porous layer in the same manner as for determining the aforesaid average particle diameter.

Said fine particles may be located in the porous layer in the form of primary particles which are not subjected to any modification, secondary particles, or higher order coagulated particles. However, said average particle diameter refers to the average diameter of particles which form independent particles in the porous layer when observed with an electron microscope.

The content of said fine particles in the water-soluble coating composition for forming the porous layer is preferably from 5 to 40 percent by weight, and is more preferably from 7 to 30 percent by weight.

Various types of additives can be incorporated into the water-soluble coating composition which forms said porous layer. Listed as said additives are, for example, cationic mordants, cross-linking agents, surface active agents (being cationic, nonionic, anionic, or amphoteric), background color modifiers, optical brighteners, antiseptics, viscosity modifiers, low-boiling-point organic solvents, high-boiling-point organic solvents, latex emulsions, anti-discoloring agents, UV absorbers, multivalent metallic compounds, (being water-soluble or water-insoluble), matting agents, and silicone oil. Of these, cationic mordants are preferred to enhance waterfastness as well as moisture resistance.

Employed as said cationic mordants are polymer mordants having a primary, secondary, or tertiary amino group or a quaternary ammonium salt group. Of these, polymer mordants having a quaternary ammonium salt group are preferred, which result in minimal discoloration as well as minimal degradation of lightfastness during storage, and exhibit sufficiently high mordant capability toward dyes.

Said preferred mordants are prepared as either homopolymers of monomers having said quaternary ammonium salt group or copolymers, and condensation polymers of said monomers with other monomers.

Further, it is particularly preferred to incorporate cross-linking agents of hydrophilic binders. The cross-linking agent is able to be comprised in the porous layer or to overcoat the dried porous layer. By employing said cross-linking agents, the waterresistance of the porous layer is enhanced, and in addition, the ink absorbing rate is also enhanced during ink jet recording due to the fact that the swelling of said hydrophilic binders is retarded.

Cross-linking agents may be employed, which include inorganic cross-linking agents (for example, chromium compounds, aluminum compounds, zirconium compounds, and boric acids), and organic cross-linking agents (for example, epoxy based cross-linking agents, isocyanate based cross-linking agents, aldehyde based cross-linking agents, N-methylol based cross-linking agents, acryloyl based cross-linking agents, vinyl sulfone based cross-linking agents, active halogen based cross-linking agents, carbodiimide based cross-linking agents, and ethyleneimine based cross-linking agents).

The content ratio of said cross-linking agents is commonly from about 1 to 50 percent by weight with respect to the hydrophilic binder, and is preferably from 2 to 40 percent by weight.

When said hydrophilic binders are comprised of polyvinyl alcohols and fine articles are comprised of silica, particularly preferred as cross-linking agents are inorganic cross-linking agents containing element of 3A, 3B, 4A or 4B in Periodic Table such as boric acids and zirconium compounds, as well as epoxy based cross-linking agents.

Multivalent metal compounds may be employed by addition in the porous layer of the present invention mentioned above.

Employed as such multivalent metallic compounds are sulfates, chlorides, nitrates, and acetates of Mg⁺², Ca²⁺, Zn²⁺, Zr²⁺, Ni²⁺, and Al³⁺. Incidentally, examples of preferred water-soluble multivalent metallic compounds include inorganic polymer compounds such as basic polyaluminum hydroxide and zirconyl acetate. By adding at least one of the multivalent metallic compounds in the porous layer, it is able to enhance lightfastness as well as waterfastness, or minimize bleeding. The content in the porous layer of these water-soluble multivalent metal ions is preferably in the range of 0.05 to 20 millimoles per m² of the recording sheet, and is preferably in the range of 0.1 to 10 millimoles.

As the support of the ink-jet recording sheet according to the invention, a water absorbable support such as paper and a water inabsorbable support may be used. Of these, the water inabsorbable support is preferred, by which a high quality image can be obtained.

Non-water-absorptive supports capable of being preferably employed in the present invention include transparent supports as well as opaque supports. Listed as said transparent supports are films comprised of materials such as polyester resins, diacetate resins, triacetate resins, acrylic based resins, polycarbonate based resins, polyvinyl chloride based resins, polyimide based resins, cellophane, and celluloid. Of these, when employed for Overhead Projectors, those, which are radiation heat resistant, are preferred, and polyethylene terephthalate is particularly preferred. Preferred as said opaque supports are, for example, resin coated paper (being so-called RC paper) in which at least one surface of the base paper is covered with a polyolefin resin layer comprised of white pigment.

For the purpose of enhancing the adhesion between said various supports and the ink receiving layer, it is preferable that prior to coating said ink receiving layer, said supports are subjected to a corona discharge treatment, as well as a subbing treatment. Further, the ink-jet recording sheets of the present invention are not necessary to be white and may be tinted.

Preferable examples of the supports are transparent polyester film, opaque polyester film, opaque polyolefin resin film and paper support laminated with polyolefin resin on both sides.

It is particularly preferable that employed as the ink-jet recording sheets of the present invention be polyethylene laminated paper supports. Said polyethylene laminated paper supports will now be described.

Base paper, employed in said paper supports, are made employing wood pulp as the main raw material, if necessary, together with synthetic pulp such as polypropylene and synthetic fiber such as nylon and polyester. Employed as said wood pulp may be any of LBKB, LBSP, NBKP, NBSP, LDP, NDP, LUKP, or NUKP. It is preferable that LBKP, NBSP, LBSP, NDP, and LDP, which are comprised of shorter fiber, are employed in a greater amount. However, the ratio of LBSP and/or LDP is preferably from 10 to 70 percent by weight.

Preferably employed as said pulp is chemical pulp (sulfate pulp and sulfite pulp). Further, also useful is pulp which has been subjected to a bleach treatment to increase its whiteness.

Into said base paper suitably incorporated may be sizing agents such as higher fatty acids and alkylketene dimers; white pigments such as calcium carbonate, talc, and titanium oxide; paper strength enhancing agents such as starch, polyacrylamide, and polyvinyl alcohol; optical brightening agent; moisture maintaining agents such as polyethylene glycols; dispersing agents; and softeners such as quaternary ammonium salts.

The degree of water freeness of pulp employed for paper making is preferably from 200 to 500 ml under CSF Specification. Further, the sum of weight percent of 24-mesh residue and weight percent of 42-mesh calculated portion regarding the fiber length after beating, specified in JIS-P-8207, is preferably between 30 and 70 percent. Further, the weight percent of 4-mesh residue is preferably 20 percent by weight or less.

The weight of said base paper is preferably from 30 to 250 g/m², and is most preferably from 50 to 200 g/m². The thickness of said base paper is preferably from 40 to 250 μm.

During the paper making stage or after paper making, said base paper may be subjected to a calendering treatment to result in excellent smoothness. The density of said base paper is generally from 0.7 to 1.2 g/m³ (JIS-P-8118). Further, the stiffness of said base paper is preferably from 20 to 200 g under the conditions specified in JIS-P-8143.

Surface sizing agents may be applied onto the base paper surface. Employed as said surface sizing agents may be the same as those above, capable of being incorporated into said base paper.

The pH of said base paper, when determined employing a hot water extraction method specified in JIS-P-8113, is preferably from 5 to 9.

Polyethylene, which is employed to laminate both surfaces of said base paper, is mainly comprised of low density polyethylene (LDPE) and/or high density polyethylene (HDPE). However, other LLDPE or polypropylene may be partially employed.

Specifically, as is generally done with photographic paper, the polyethylene layer located on the ink receiving layer side is preferably constituted employing polyethylene into which rutile or anatase type titanium oxide is incorporated so that opacity as well as whiteness is improved. The content ratio of said titanium oxide is generally from 1 to 20 percent by weight with respect to polyethylene, and is more preferably from 2 to 15 percent by weight.

It is possible to employ said polyethylene coated paper as glossy paper. Further, in the present invention, it is possible to employ polyethylene coated paper with a matt or silk surface, as obtained in the conventional photographic paper, by carrying out an embossing treatment during extrusion coating of polyethylene onto said base paper.

The used amount of polyethylene on both surfaces of said paper is selected so as to optimize the layer thickness of a water based coating composition as well as curling at low and high humidity after providing a back layer. The thickness of the polyethylene layer on the side onto which the water based coating composition in accordance with the present invention is applied, is preferably in the range of 20 to 40 μm, while the thickness of the polyethylene layer on the opposite side is preferably in the range of 10 to 30 μm.

Further, it is preferable that said polyethylene coated substrate exhibits the characteristics described below.

(1) Tensile strength is preferably from 20 to 300 N in the longitudinal direction and from 10 to 200 N in the lateral direction, in terms of the strength specified in JIS P 8113.

(2) Tear strength is preferably from 0.1 to 2 N in the longitudinal direction and from 0.2 to 2 N in the lateral direction in terms of the tear strength specified in JIS P 8116.

(3) Compression elasticity is no less than 1,030 N/cm².

(4) Bekk surface smoothness is preferably at least 500 seconds under conditions specified in JIS P 8119, however so-called embossed papers may exhibit less than that.

(5) Bekk rear surface smoothness is preferably from 100 to 800 seconds under conditions specified in JIS P 8119.

(6) Opacity is preferably no more than 20 percent and is most preferably no more than 15 percent in terms of the transmittance of light in the visible region, which is determined under conditions of parallel light incidence/diffused light transmission.

(7) Whiteness is preferably at least 90 percent in terms of Hunter's brightness specified in JIS P 8123. Further, when measurement is carried out utilizing JIS Z 8722 (non-fluorescence) and JIS Z 8717 (incorporation of fluorescent agents) and the color is represented utilizing the color specification specified in JIS Z 8730, it is preferable that L*=90 to 98, a*=−5 to +5, and b*=−10 to +5.

For the purpose of enhancing adhesion to the ink receptive layer, a subbing layer is preferably provided on the ink receptive layer side of said substrate. Binders for said subbing layer are preferably hydrophilic polymers such as gelatin, polyvinyl alcohols, and latex polymers having a Tg of −30 to 60° C. Said binders are employed in an amount of 0.001 to 2 g per m² of the recording sheet. For the purpose of minimizing static charge, a small amount of antistatic agent such as cationic polymers, conventionally known in the art, may be incorporated.

For the purpose of improving slipping properties as well as electrification characteristics, a back layer may be provided on the surface opposite the ink receptive layer of said substrate. Binders for said back layer are preferably hydrophilic polymers such as gelatin, polyvinyl alcohols, and latex polymers having a Tg of −30 to 60° C. Further, also incorporated may be antistatic agents such as cationic polymers, various types of surface active agents, and in addition, about 0.5 to about 20 μm matting agents. The thickness of said backing layer is from about 0.1 to about 1 μm. However, when said backing layer is provided to minimize curling, its thickness is to be from about 1 to about 20 μm. Further, said backing layer may be comprised of at least two layers.

When said subbing layer, as well as said back layer, is coated, surface treatments such as a corona treatment or a plasma treatment applied onto the substrate surface are preferably employed in combination.

The production method of the ink-jet recording sheet according to the invention is described below.

The ink-jet recording sheet according to the invention can be produced by the following procedure: a layer contained the fine particles to the binder containing the hydrophilic polymer compound having the plural side chains on the main chain thereof and a polymerization degree of not less than 300 is provided on the support, then the ionizing radiation from a light source such as a mercury lamp or a metal halide lamp for occurring crosslinking through the side chains of the hydrophilic polymer compound to form the porous layer. In such the producing method, it is not necessary to hold the coated layer at low temperature or to add a crosslinking agent to the porous layer for setting the binder so that the coated layer can be rapidly dried at high temperature and unevenness of the layer such as the mottle formed by blowing can be inhibited.

Particularly preferably to form the porous layer by providing the coated layer on the support by coating the coating composition which contains the fine particles to the binder containing the hydrophilic polymer compound having plural side chains on the main chain thereof and a polymerization degree of not less than 300, and irradiating the ionizing radiation to the polymer compound for forming the crosslinkage between the side chains to form the porous layer.

Next, the preferable producing method of the ink-jet recording sheet according to the invention is concretely described.

Firstly, the hydrophilic polymer compound having plural side chains on the main chain thereof and a polymerization degree of not less than 300, and another hydrophilic polymer compound according to necessity, as the binder is mixed with fine particles as the filler in the presence of a surfactant according to necessity and dispersed, and then the foregoing additive is further mixed according to necessity to prepare an aqueous coating composition. The aqueous coating composition is coated on at least one side of the support to form the coated layer for forming the porous layer.

The porous layer in accordance with the recording sheet of the present invention may be comprised of a single layer or a multilayer. In the case of said multilayer, from the viewpoint of reducing production cost, it is preferable that all the layers be simultaneously coated.

It is possible to coat said coating composition employing a method which is suitably selected from the several methods. Preferably employed coating methods include, for example, a gravure coating method, a roll coating method, a rod bar coating method, an air knife coating method, a spray coating method, an extrusion coating method, a curtain coating method, or an extrusion coating method employing a hopper, described in U.S. Pat. No. 2,681,294.

Thereafter, the coated layer is irradiated by the ionizing radiation such as ultraviolet ray from a mercury lamp or a metal halide lamp. The crosslinkage is formed through the side chains by irradiating the ionizing radiation so that the layer is gelled and by raising the viscoelasticity of the coated layer inhibiting the fluid of the coated layer. Thus the uniform coated layer can be formed. The coated layer is dried after the irradiation, thus the ink-jet recording sheet on which the uniform porous layer having the volume of the void mainly comprising the hydrophilic binder and the fine particles can be obtain.

It is preferred in the invention that the coated layer is dried after the irradiation by the ionizing radiation to evaporate the aqueous solvent principally composed of water. A part or almost of the solvent may have been evaporated on the occasion of the irradiation by the ionizing radiation. However, it is preferable that the irradiation of the ionizing radiation is applied to the coated layer in a state of containing the aqueous solvent, and is more preferable that the irradiation of the ionizing radiation is applied just after the coating. It is become not necessary to hold the porous layer at low temperature or to add the crosslinking agent to the layer coated and high production efficiency can be attained since the crosslinking through the side chains of the hydrophilic polymer compound in the coated layer are formed, and the layer can be rapidly dried at high temperature. Consequently, the unevenness of the layer such as the mottles by caused blowing can be inhibited. Thus the ink-jet recording sheet can be obtained having the uniform porous layer.

It is preferable to irradiate the ionizing radiation when the ratio of solvent to the solid components in the coated layer is not less than 100% by weight.

It is more preferable to further irradiate the ionizing radiation when the ratio of solvent to the solid components in the layer is become until less than 100% by weight.

The irradiation of the ionizing radiation is preferably applied so that the elastic modulus and the viscosity coefficient are also become to 1.5 times, more preferably 3.0 times, of those before the irradiation. Strong gel structure can be formed by such the production method; consequently, the void can be efficiently formed and maintained without influence of the drying stress on the occasion of the drying. Furthermore, it is not necessary to hold the porous layer a low temperature or to add the crosslinking agent for setting the binder, and the layer can be rapidly dried at high temperature and high production efficiency can be attained and the unevenness of the layer such as the blow mottles can be inhibited.

The viscosity coefficient and the elastic modulus are values measured by a viscoelasticity measuring apparatus. For example, the viscoelasticity is determined by vibration analysis of the rigid pendulum swing cycle as to the coated layer measured by a rigid pendulum type viscoelasticity measuring apparatus RPT-3000W manufactured by A and D Co., Ltd. The reciprocal of the swing cycle of rigid pendulum is the elastic modulus and the logarithmic attenuation of the swing cycle is the viscosity coefficient.

It is preferable from the viewpoint of the formation of the void to remove the solvent as rapid as possible after the formation of the gel structure.

As above-mentioned, it is preferred that the irradiation of the ionizing radiation is applied after coating for gelling the coated liquid by crosslinking through the side chains of the polymer compound contained in the coated layer so that the coated layer has suitability to the drying blow; the irradiation is further applied just before the solvent content of the coated layer is become 100% for strengthening the gel structure; or/and the drying temperature is rapidly raised for rapidly remove the solvent contained in the coated layer.

The solvent content is the amount of solvent to that of the whole solid components in the coating composition, which is measured by weighing.

An aqueous coating composition prepared by mixing such photosensitive resins with fine particles is applied onto at least one side of a support. Thereafter, the resulting coating is cured while exposed to ionizing radiation, whereby an ink-jet recording sheet comprising the void type porous layer according to the present invention is prepared. Examples of ionizing radiation include electron beams, ultraviolet radiation, α-rays, β-rays, γ-rays, and X-rays. Preferably employed are electron beams and ultraviolet radiation, which do not have the large influence on a human body and are easily handled and thus widely employed in industry.

When electron beams are employed, the exposure amount of the aforesaid electron beam is preferably controlled to be in the range of 0.1-20 Mrad. An exposure amount of not less than 0.1 Mrad does not result in sufficient exposure effects. An exposure amount of at not more than 20 Mrad is not preferred because it is able to avoid deteriorating deteriorate supports, especially paper and certain type of plastics. Accepted as electron beam exposure systems are, for example, a scanning system, a curtain beam system, and a broad beam system. Appropriate acceleration voltage during electron beam exposure is 100-300 kV. Incidentally, the aforesaid electron beam exposure system exhibits advantages such that, compared to the ultraviolet radiation exposure, higher productivity can be achieved, problems such as unpleasant odor and coloration due to the addition of sensitizers do not occur, and further, uniform crosslinking structures are easily achieved.

The aforesaid hydrophilic polymer compounds having the polymerization degree of not less than 300 and the plurality of side chains on the main chain thereof, which are preferably employed in the present invention, are sensitive to, for example, ultraviolet radiation without adding the sensitizers described below and are capable of readily undergoing a crosslinking reaction. Employed as radiation sources of the ultraviolet radiation are UV lamps (e.g., low pressure, medium pressure, and high pressure mercury lamps having an operating pressure of 0.5-1 MPa), xenon lamps, tungsten lamps, and halogen lamps. The intensity of the exposed ultraviolet radiation is preferably about 5,000- about 8,000 μW/cm². Energy requirement for crosslinking through the side chains is in the range of 0.02-20 kJ/cm².

Further, when ultrviolet radiation is employed, sensitizers may be incorporated in coating compositions. For example, sensitizers such as thioxanthone, benzoin, benzoin alkyl ether xanthone, dimethylxanthone, benzophenone, and 1,1-dichloroacetophenone may be incorporated individually or in combinations of at least two types.

Incidentally, when sensitizers are employed, the used amount thereof is customarily controlled to be in the range of 0.2-10 percent by weight with respect to the ionizing radiation crosslinkable type polymer compound in the coating composition, and preferably in the range of 0.5-5 percent by weight. Further, tertiary amines such as triethanolamine, 2-dimethylaminoethanol, and dimethylaminobenzoic acid may be mixed in coating compositions in an amount of 0.05-3 percent by weight with respect to the ionizing radiation type polymer compound.

A good layer surface can be obtained by the drying at relatively low temperature since the occurrence of cracks can be inhibited, which is caused by breaking of the hydrogen bond between the binder and the fine particle by molecular movement according to the temperature raising of the coated layer. In such the case, the temperature of the coated layer during the drying is preferably not more than 50° C., and is more preferably not less than 40° C.

The polymer compound crosslinked by the irradiation of the ionizing radiation has higher resistively to the temperature rising of the coated layer than the weak bonding such as hydrogen bond. Accordingly, the dying temperature can be raised after the irradiation of the ionizing radiation and the high speed coating can be easily performed.

After the irradiation of the ionizing radiation, the temperature of the coated layer during the drying is preferably from 50° C. to 80° C., and is more preferably from 60° C. to 70° C.

In the invention, the drying speed can be raised and the high product efficiency can be obtained since the drying temperature can be raised after the irradiation of the ionizing radiation by 10° C. or more compared with that before the irradiation.

It is preferred that the recording paper according to the invention is preferably stored for 1 day to one month, more preferably for 1 to 3 days from the viewpoint of the cost, after wound in the rolled state or cut into a roll or sheet state.

### EXAMPLES

The present invention will now be described with reference to examples. The term “percent” in the examples refers to percent by weight, unless otherwise specified.

### Example A

### Example 1

While stirring, gradually added to 100 g of a silica dispersion (at a pH of 4, while containing one percent by weight of ethanol) containing 25 percent of previously, uniformly dispersed vapor phase method silica (Aerosil 200, manufactured by Nippon Aerosil Co., Ltd.) was 35 g of an aqueous stilbazolium group-introduced photo-crosslinkable polyvinyl alcohol derivative solution (SPP-SHR main chain PVA having a degree of polymerization of 2,300 and a saponification ratio of 88 percent, manufactured by Toyo Gosei Co., Ltd.) in which the concentration was adjusted to 10 percent.

Subsequently, dispersion was carried out at a pressure of 3,000 N/cm², employing a high pressure homogenizer. The total weight of the resulting dispersion was adjusted to 200 g by adding pure water, whereby a liquid coating composition was prepared.

The liquid coating composition, prepared as above, was applied onto a polyethylene-coated paper (8 percent by weight of anatase type titanium oxide was incorporated in polyethylene on the ink receiving layer side; 0.05 g/m² gelatin sublayer was applied onto the ink receiving layer surface side, while on the opposite side, a 0.2 g/m² backing layer comprised of latex polymer, having a Tg of about 80° C. was provided), at a wet coating thickness of 180 μm, employing a bar coater. The polyethylene-coated paper was previously prepared by covering both sides of 170 g/m² base paper. Thereafter, the resulting coating was exposed to ultraviolet radiation at an energy level of 2 kJ/cm², employing a metal halide lamp, having a dominant wavelength of 365 nm. Thereafter, drying was carried out at 80° C., employing a hot air type oven, whereby ink-jet recording sheet was prepared.

The volume of the void of the ink-jet recording sheet, as prepared herein, was 23 ml/m². The diameter of the silica particles in the porous layer of the ink-jet recording sheet measured by electromicroscope observation was 50 nm.

The volume of the void was determined by the amount of liquid transfer during the contact time of 2 seconds according to the test method of liquid absorption of paper and cardboard (Bristow method) defined in J. TAPPI 51.

### Example 2

Ink-jet recording sheet was prepared in the same manner as in Example 1 except that the coating composition was made up to 200 g by purified water without the use of a 40% solution of aluminum basic polyhydroxide.

The diameter of the silica particles in the porous layer of thus prepared ink-jet recording sheet measured by electronmicroscope observation was 50 nm and the volume of the void was 23 ml/m².

### Example 3

Ink-jet recording sheet was prepared in the same manner as in Example 1 except that the vapor phase method was replaced by silica by gelation method Nipgell AZ200, produced by Nihon Silica Kogyo Co., Ltd., which was dispersed by a sand mill dispersing machine so that the average diameter is become 0.45 μm.

The diameter of the silica particles in the porous layer of thus prepared ink-jet recording sheet measured by electronmicroscope observation was 0.45 μm and the volume of the void was 22 ml/m².

### Example 4

Ink-jet recording sheet was prepared in the same manner as in Example 3 except that the coating composition was made up to 200 g by purified water without the use of the 40% solution of aluminum basic polyhydroxide.

The diameter of the silica particles in the porous layer of thus prepared ink-jet recording sheet measured by electronmicroscope observation was 0.45 μm and the volume of the void was 22 ml/m².

### Example 5

Ink-jet recording sheet was prepared in the same manner as in Example 1 except that the adding amount of the aqueous solution of the photo-crosslinkable polyvinyl alcohol derivative was changed to 14.7 g.

The diameter of the silica particles in the porous layer of thus prepared ink-jet recording sheet measured by electronmicroscope observation was 50 nm and the volume of the void was 23 ml/m².

### Example 6

Ink-jet recording sheet was prepared in the same manner as in Example 1 except that photo-crosslinkable polyvinyl alcohol derivative SPP-SHR having a PVA polymerization degree of 2300 and a saponification degree of 88%, produced by Toyo Gosei Kogyo Co., Ltd., was replaced by a photo-crosslinkable Polyvinyl alcohol derivative which is PVA having a main chain polymerization degree of 2300 introduced with 1 mole-% of the photo-crosslinking group represented by formula (I).

The diameter of the silica particles in the porous layer of thus prepared ink-jet recording sheet measured by electronmicroscope observation was 50 nm and the volume of the void was 23 ml/m².

### Example 7

Ink-jet recording sheet was prepared in the same manner as in Example 6 except that the coating composition was made up to 200 g by purified water without the use of the 40% solution of aluminum basic polyhydroxide.

The diameter of the silica particles in the porous layer of thus prepared ink-jet recording sheet measured by electronmicroscope observation was 50 nm and the volume of the void was 23 ml/m².

### Example 8

Ink-jet recording sheet was prepared in the same manner as in Example 6 except that the vapor phase method silica by was replaced by silica by gelation method Nipgell AZ200, produced by Nihon Silica Kogyo Co., Ltd., which was dispersed by a sand mill dispersing machine so that the average diameter is become 0.45 μm.

The diameter of the silica particles in the porous layer of thus prepared ink-jet recording sheet measured by electronmicroscope observation was 0.45 μm and the volume of the void was 22 ml/m².

### Example 9

Ink-jet recording sheet was prepared in the same manner as in Example 8 except that the coating composition was made up to 200 g by purified water without the use of the 40% solution of aluminum basic polyhydroxide.

The diameter of the silica particles in the porous layer of thus prepared ink-jet recording sheet measured by electronmicroscope observation was 0.45 μm and the volume of the void was 22 ml/m².

### Comparative Example 1

Ink-jet recording sheet was prepared in the same manner as in Example 2 except that the irradiation of the ultraviolet radiation was omitted.

The volume of the void of thus obtained recording paper could not be measured since many cracks occurred on the recording paper.

### Comparative Example 2

Ink-jet recording sheet was prepared in the same manner as in Example 2 except that the polyvinyl alcohol derivative was replaced by polyvinyl alcohol having a polymerization degree of 2300 and a saponification degree of 88% and 0.5 g of boric acid, and made up 200 g by purified water and the irradiation of the ultraviolet radiation was omitted.

The volume of the void of thus obtained recording paper could not be measured since many cracks occurred on the recording paper.

### Comparative Example 3

Ink-jet recording sheet was prepared in the same manner as in Example 2 except that the polyvinyl alcohol derivative was replace by an electron polymerizable compound NK Ester A-TMM-3, produced by Shin Nakamura Kagaku Co., Ltd., and an irradiation amount of 4 Mrad of electron ray accelerated by accelerating voltage of 200 kV was irradiated in place of ultraviolet ray.

The volume of the void of thus obtained ink-jet recording sheet was 11 ml/m².

### Comparative Example 4

Recording paper was prepared in the same manner as in Example 4 except that ultraviolet ray was not irradiated.

The volume of the void of thus obtained recording paper could not be measured since many cracks occurred on the recording paper.

### Comparative Example 5

Recording paper was prepared in the same manner as in Example 5 except that ultraviolet ray was not irradiated.

The volume of the void of thus obtained recording paper could not be measured since many cracks occurred on the recording paper.

### Comparative Example 6

Recording paper was prepared in the same manner as in Comparative Example 2 except that a coating composition was used which is prepared by adding 500 mg of a 40% solution of aluminum basic polyhydroxide and being made up to 200 g by purified water.

The volume of the void of thus obtained recording paper could not be measured since many cracks occurred on the recording paper.

### Comparative Example 7

Ink-jet recording sheet was prepared in the same manner as in Example 1 except that a 10% solution of the photo-crosslinkable polyvinyl alcohol derivative was only coated so that the thickness was 180 μm and irradiation of the ionizing radiation was not applied.

The volume of the void of thus obtained ink-jet recording sheet was 5 ml/m².

### Comparative Example 8

Ink-jet recording sheet was prepared in the same manner as in Comparative Example 7 except that the polyvinyl alcohol derivative was replaced by polyvinyl alcohol having a polymerization degree of 2300 and a saponification degree of 88% and 0.5 g of boric acid, and made up 200 g by purified water.

The volume of the void of thus obtained ink-jet recording sheet was 4 ml/m².

### Comparative Example 9

Ink-jet recording sheet was prepared in the same manner as in Example 2 except that the polymerization degree of the main chain was changed to 250.

The volume of the void of thus obtained ink-jet recording sheet was 22 ml/m².

### Comparative Example 10

Ink-jet recording sheet was prepared in the same manner as in Example 1 except that the polymerization degree of the main chain was changed to 250.

The volume of the void of thus obtained ink-jet recording sheet was 22 ml/m².

Recording Papers prepared in Examples 1-9, and Comparative Example 1-10 were stored at 40° C. for three days and stabilized.

(Evaluation of Characteristics of Recording Sheets)

The layer surface state, the ink absorbability, the water resistance, the image bleeding, the fissures by folding and the color appearing property of each of the recording sheets, prepared as above, were evaluated employing the methods described below.

Layer surface state: Layer surface smoothness and the number of cracks per 10 cm² of the layer were visually evaluated.

The layer surface smoothness was evaluated based on the criteria below.

A: No undulations were noticed, resulting in desired smoothness

B: Long cycle undulations were slightly noticed, but resulting in no problem as a commercial product

C: Partial layer surface problems were noticed, at a level in which an air-blown surface was evident

D: Short cycle undulations of the layer surface were noticed at a level of no commercial viability

E: Short cycle undulations due to blown air were noticed and many layer surface problems occurred, resulting in a level of no commercial viability

Ink absorbability: A neutral gray original at a reflecting density of approximately 1.0 was wholly printed employing an Ink Jet Printer PM900C, manufactured by Seiko Epson Corp. The presence and absence of non-uniformity was visually evaluated based on the 5 ranks below.

1: High uniformity was noticed

2: Slight non-uniformity was noticed, resulting in no practical problems, even when the whole original was printed

3: Non-uniformity was clearly noticed, when the whole original was printed, however resulting in almost no practical problems

4: Gray colored non-uniformity was noticed, resulting in practically unacceptable prints

5: Completely unacceptable prints

In the aforesaid evaluation rank, 4 and 5 were deemed to be no commercial viability.

Water resistance: Each of the prepared ink jet recording sheets was immersed into water for two minutes. After removal from water, the surface was rubbed with fingers 5 times and the resulting state was visually observed.

A: No change was noticed

B: Slight streaking was noticed, however resulting in no practical problems

C: Streaking was clearly noticed, but still resulting in a practically acceptable level

D: The surface was abraded away, resulting in a practically unacceptable print

E: The recording layer was severely damaged, resulting in an entirely unacceptable print

Image bleeding: An image in which five 1 mm wide lines were drawn employing a black ink on a pattern of 100 percent magenta was printed employing an Ink Jet Printer PM900, manufactured by Seiko Epson Corp., and the resulting print was dried at 25° C. and relative humidity of 55 percent for 6 hours. Thereafter, the resulting image was allowed to stand at an ambience of 40° C. and 80 percent relative humidity for 3 days. Bleeding was then evaluated at the 5 ranks based on the criteria described below.

1: No increase in the line width was noticed

2: A slight increase in the line width was noticed, however at a level which caused no practical problems

3: An increase in the line width at a factor of approximately 1.5 was noticed resulting in a level in which the image was not durable for storage over an extended period of time

4: An increase in the line width at a factor of at least 2 was noticed, resulting in a practically unacceptable print

5: An entirely unacceptable print

In the aforesaid ranks, 4 and 5 were deemed to be no commercial viability.

Fissure by folding: A recording sheet was cut into a 5×10 cm rectangle. The resulting rectangular sheet was wound onto a paper core having an inner core diameter of 3 cm, and the resulting fissure by folding was visually evaluated based on the criteria comprised of these 5 ranks.

A: No fissure by folding was noticed

B: 5 or fewer of fissures by folding were noticed

C: 6-20 fissures by folding were noticed

D: 21-100 fissures by folding were noticed

E: at least 100 fissures by folding were noticed

Color appearing property: the maximum density of black was printed by ink-jet printer PM-900 manufactured by Seiko-Epson Co., Ltd., and the density of the printed image was measured.

TABLE 1

| | Surface | | | | | | |
|---|---|---|---|---|---|---|---|
| | condition | | | | | | |
| | Surface | | | | | Fissures | |
| | smooth- | | | | | by | Black |
| | ness | Cracks | *1 | *2 | *3 | density | |
| Example 1 | A | None | 1 | A | 1 | A | 2.48 |
| Example 2 | A | None | 1 | A | 2 | A | 2.46 |
| Example 3 | A | None | 1 | A | 1 | A | 2.01 |
| Example 4 | A | None | 1 | B | 2 | A | 2.03 |
| Example 5 | A | None | 1 | B | 1 | B | 2.02 |
| Example 6 | A | None | 1 | B | 1 | A | 2.39 |
| Example 7 | A | None | 1 | B | 2 | A | 2.36 |
| Example 8 | A | None | 1 | B | 1 | B | 2.08 |
| Example 9 | A | None | 1 | B | 2 | B | 2.04 |
| Comparative | E | 121 | 3 | C | 4 | D | 2.44 |
| example 1 | | | | | | | |
| Comparative | C | 88 | 1 | B | 3 | E | 2.38 |
| example 2 | | | | | | | |
| Comparative | C* | —* | 1 | A | 3 | C | 2.29 |
| example 3 | | | | | | | |
| Comparative | D | 18 | 2 | C | 3 | D | 1.98 |
| example 4 | | | | | | | |
| Comparative | D | 64 | 1 | C | 3 | D | 1.87 |
| example 5 | | | | | | | |
| Comparative | C | 106 | 1 | B | 1 | D | 2.10 |
| example 6 | | | | | | | |
| Comparative | A | None | 5 | E | 5 | A | 2.44 |
| example 7 | | | | | | | |
| Comparative | A | None | 5 | C | 5 | A | 2.14 |
| example 8 | | | | | | | |
| Comparative | A | None | 2 | B | 2 | E | 2.19 |
| example 9 | | | | | | | |
| Comparative | A | None | 2 | A | 1 | E | 2.21 |
| example 10 | | | | | | | |

Note
*Non-uniformity due to blown drying air
*1; Ink Absorbability
*2; Water resistance
*3; Image bleeding

### Example B

To 100 kg of silica dispersion having a pH of 4.0 and containing 1% by weight of methanol which contains previously dispersed 25% of vapor phase method silica produced by having an average diameter of primary particles of 0.012 μm, Aerosil 200, produced by Nihon Aerosil Co., Ltd., 35.7 kg of an aqueous solution of photo-crosslinkable polyvinyl alcohol SPP SHR, produced by Toyo Gosei Kogyo Co., Ltd., having a main chain polymerization degree of 2300 and saponification degree of 88% which is introduced with a styrylpyridinium (stilbazolium) group and its concentration was adjusted to 10%, was gradually added while stirring.

Then the resultant mixture was dispersed by a high pressure homogenizer applying a pressure of 3,000 N/cm², and made up to 150 l by purified water to prepare Coating composition A.

The above coating composition was filtered through a filter Type TCP-30, produced by Advantec-Toyo Co., Ltd., having a filtering accuracy of 30 μm.

Then the coating composition was coated at 40° C. by a slide hopper coater on a paper support on both sides thereof covered with polyethylene at so that the wet layer thickness was 130 μm.

As the paper support, the following paper support wound in a form of a roll, having a width of 1.5 m and a length of 4,000 m.

On one surface of raw paper having a weight of 170 g/m² and a solvent content of 8%, a 35 μm layer of molten polyethylene containing 6% of anatase type titanium oxide was laminated by a extrusion coating method and a 40 μm layer of molten polyethylene was laminated by the extrusion coating method on the back surface of the raw paper to prepare the above-mentioned paper support. Then the surface of the support was subjected to corona discharge and coated with a subbing layer of polyvinyl alcohol PVA235, produced by Kuraray Co., Ltd., with a coating amount of 0.05 g per square meter of the recording paper, the back surface of the support was subjected to corona discharge and coated with a backing layer containing 0.4 g of styrene/acrylate latex binder having a Tg of about 80° C., 0.1 g of a cationic polymer as an anti-static agent and 0.1 g of silica having a diameter of 2 μm as a matting agent.

After the coating of the coating solution, the coated layer was subjected to irradiation of 2 kj/cm² of ultraviolet ray having a principal wavelength of 365 nm by a metal halide lamp at just before the first zone and the end the 6th zone. Thereafter, the coated support was dried by passing through the following zones while successively blowing warmed air, and wound into a roll to obtain Comparative Recording paper 1. The average relative humidity of the blown air was not more than 30% except for the 10th zone. The 10th zone was a moisture controlling zone in which the relative humidity of air was 40 through 60%.

The elastic modulus of the coated layer just after the irradiation by ultraviolet ray just before the 1st zone was 3 times of that of the coated layer before the irradiation, and the viscosity coefficient of the irradiated layer was 3 times of that of the layer before the irradiation.

Drying conditions in each of zones were as follows; the temperature was the temperature of the atmosphere in each of the zones.

1st zone: 20° C., 30 seconds

2nd zone: 60° C., 30 seconds

3rd zone: 60° C., 30 seconds

4th zone: 60° C., 30 seconds

5th zone: 60° C., 30 seconds

6th zone: 60° C., 30 seconds

7th zone: 60° C., 30 seconds

8th zone: 40° C., 30 seconds

9th zone: 30° C., 30 seconds

10th zone: 25° C., 90 seconds

The temperature of the atmosphere just before the first zone was 15° C. and the solvent content of the coated layer at the same position was no less than 100%.

In this example, the drying conditions in each of the zones were previously set so that the solvent content of the coated layer at the end of the 6th zone was 80%. The volume of the void in thus prepared Recording Paper 1 was 23 ml per square meter of the recording paper.

The volume of the void was determined by the amount of liquid transfer during the contact time of 2 seconds according to the test method of liquid absorption of paper and cardboard (Bristow method) defined in J. TAPPI 51.

### Example 2

Recording Paper 2 was prepared in the same manner as in Example 1 except that the irradiation of ultraviolet ray at the end of the 6th zone was not applied. The volume of the void in thus prepared Recording Paper 2 was 23.6 ml per square meter of the recording paper.

### Example 3

Recording Paper 3 was prepared in the same manner as in Example 1 except that the temperature in each of the drying zones was set as follows and the irradiation of ultraviolet ray was applied just before the 1st zone and at the end of the 9th zone.

1st zone: 20° C., 30 seconds

2nd zone: 30° C., 30 seconds

3rd zone: 30° C., 30 seconds

4th zone: 30° C., 30 seconds

5th zone: 30° C., 30 seconds

6th zone: 30° C., 30 seconds

7th zone: 30° C., 30 seconds

8th zone: 30° C., 30 seconds

9th zone: 30° C., 30 seconds

10th zone: 30° C., 30 seconds

The temperature of the atmosphere just before the first zone was 15° C. and the solvent content of the coated layer at the same position was not less than 100%.

In this example, the drying conditions in each of the zones were previously set so that the solvent content of the coated layer at the end of the 9th zone was 85%.

The elastic modulus of the coated layer just after the irradiation by ultraviolet ray just before the 1st zone was 3 times of that of the coated layer before the irradiation, and the viscosity coefficient of the irradiated layer was 3 times of that of the layer before the irradiation. The volume of the void in thus prepared Recording Paper 3 was 23.4 ml per square meter of the recording paper.

### Example 4

Recording Paper 4 was prepared in the same manner as in Example 1 except that energy of the irradiated ultraviolet ray was changed to 12 mJ/cm². The elastic modulus of the coated layer just after the irradiation by ultraviolet ray just before the 1st zone was 1.1 times of that of the coated layer before the irradiation, and the viscosity coefficient of the irradiated layer was 1.2 times of that of the layer before the irradiation. The volume of the void in thus prepared Recording Paper 4 was 24.1 ml per square meter of the recording paper.

### Example 5

Recording Paper 5 was prepared in the same manner as in Example 1 except that the ultraviolet ray irradiation at the end of the 6th zone was not applied. The volume of the void in thus prepared Recording Paper 4 was 23.5 ml per square meter of the recording paper.

### Example 6

Recording Paper 6 was prepared in the same manner as in Example 3 except that energy of the irradiated ultraviolet ray was changed to 12 mJ/cm². The setting of temperature in each of the zones and the position of the irradiation were the same as those in Example 3. The elastic modulus of the coated layer just after the irradiation by ultraviolet ray at just before the first zone was 1.1 times of that of the coated layer before the irradiation, and the viscosity coefficient of the irradiated layer was 1.2 times of that of the layer before the irradiation. The volume of the void in thus prepared Recording Paper 6 was 23.6 ml per square meter of the recording paper.

### Example 7

Recording Paper 7 was prepared in the same manner as in Example 3 except that the ultraviolet ray irradiation at the end of the 9th zone was not performed. The volume of the void in thus prepared Recording Paper 7 was 23.1 ml per square meter of the recording paper.

### Example 8

Recording Paper 8 was prepared in the same manner as in Example 6 except that the ultraviolet ray irradiation at the end of the 9th zone was not performed. The volume of the void in thus prepared Recording Paper 8 was 22.9 ml per square meter of the recording paper.

### Example 9

Recording Paper 9 was prepared by storing the recording paper obtained in Example 1 for 24 hours at 40° C.

### Example 10

Recording Paper 10 was prepared in the same manner as in Example 7 except that the adding amount of the aqueous solution of the photo-crosslinkable polyvinyl alcohol derivative was changed to 14.7 kg. The volume of the void in thus prepared Recording Paper 10 was 23.7 ml per square meter of the recording paper.

### Example 11

Recording Paper 11 was prepared in the same manner as in Example 3 except that the adding amount of the aqueous solution of the photo-crosslinkable polyvinyl alcohol derivative was changed to 14.7 kg. The elastic modulus of the coated layer just after the irradiation by ultraviolet ray just before the 1st zone was 1.1 times of that of the coated layer before the irradiation, and the viscosity coefficient of the irradiated layer was 1.2 times of that of the layer before the irradiation. The volume of the void in thus prepared Recording Paper 11 was 24.1 ml per square meter of the recording paper.

### Example 12

Recording Paper 12 was prepared in the same manner as in Example 7 except that the adding amount of the aqueous solution of the photo-crosslinkable polyvinyl alcohol derivative was changed to 14.7 kg. The elastic modulus of the coated layer just after the irradiation by ultraviolet ray just before the 1st zone was 1.1 times of that of the coated layer before the irradiation, and the viscosity coefficient of the irradiated layer was 1.2 times of that of the layer before the irradiation. The volume of the void in thus prepared Recording Paper 12 was 23 ml per square meter of the recording paper.

### Example 13

Recording Paper 13 was prepared in the same manner as in Example 1 except that the adding amount of the aqueous solution of the photo-crosslinkable polyvinyl alcohol derivative was changed to 14.7 kg. Comparative examples are described below.

### Comparative Example 1

Recording Paper 14 was prepared in the same manner as in Example 1 except that the 10% aqueous solution of the photo-crosslinkable polyvinyl alcohol derivative was only coated so that the layer thickness was 150 μm.

### Comparative Example 2

Recording Paper 15 was prepared in the same manner as in Example 1 except that the 10% aqueous solution of the photo-crosslinkable polyvinyl alcohol derivative was replaced by 10% aqueous solution of a 10% polyvinyl alcohol having a polymerization degree of 3,500 and a saponification degree of 88% was used and 178 g of boric acid was added, and the ultraviolet ray was not applied.

### Comparative Example 3

Recording Paper 16 was prepared in the same manner as in Example 2 except that the 10% aqueous solution of the photo-crosslinkable polyvinyl alcohol derivative was replaced by an electron polymerizable compound NK Ester A-TMN-3, produced by Shin Nakamura Kagaku Co., Ltd., and 4 Mrad of electron ray with an acceleration voltage of 200 kV was irradiated in stead of ultraviolet ray.

### Comparative Example 4

Recording Paper 17 was prepared in the same manner as in Example 1 except that ultraviolet ray is not irradiated just before the 1st zone.

### Comparative Example 5

Recording Paper 18 was prepared in the same manner as in Example 7 except that ultraviolet ray is not irradiated just before the 1st zone.

### Comparative Example 6

Recording Paper 1 was prepared in the same manner as in Example 6 except that ultraviolet ray is not irradiated jat the end of the 9th zone.

<Evaluation of Recording Paper>

The recording papers prepared as above were each subjected to the evaluation as to the surface condition, ink absorbability, fissures occurrence by folding and absorption volume according to the following methods. Surface condition: the smoothness of the surface and the number of cracks per 10 cm² of the layer were visually evaluated.

The smoothness of surface was evaluated according to the following norm.

A: The surface was smooth and any waving was not observed.

B: Some degree of long cycle waving was observed, the level of which caused no problem in practical use.

C: Partial surface defects and apparent unevenness caused by blowing are observed.

D: Cyclic waving of the layer surface was observed, the level of which is not acceptable for practical use.

E: Short cyclic waving caused by blowing and many surface defects occurred, the level of which is not acceptable at all for practical use.

Fissures by folding: The recording paper cut into the size of 5×10 cm was wound on a paper pipe 2 with an interior diameter of 3 cm and formed cracks were visually evaluated into the five ranks.

A: No fissure occurred

B: Number of fissures was five or less.

C: Number of fissures was from 6 to 20

D: Number of fissures was from 21 to 100

E: Number of fissures was more than 100

Ink absorbability: The image of a patch of which output of cyan and yellow was 255 was fully printed by Ink-jet Printer PM900C, manufactured by Seiko-Epson Co., Ltd., and the printed image was visually evaluated and classified into the following ranks.

1: Unevenness of image was not observed at all.

2: Unevenness of image was slightly by careful observation but the level of which caused no problem in practical use.

3: Dot-shaped unevenness was observed but the level of which caused no problem in the practical printing.

4: Unevenness was observed but the level of which caused almost no problem in the practical printing.

5: Unevenness was observed but the level of which is caused not problem depending on the kind of the image.

6: Color unevenness was observed, the level of which was not acceptable for practical use.

7: Flowed ink formed sea-island pattern, the level of which was not acceptable for practical use.

8: Flowed ink formed caused color contamination, the level of which was not acceptable for practical use.

9: Flowed ink was difficultly dried, the level of which was not acceptable for practical use.

10: The level of defect occurrence was not acceptable at all.

In the aforesaid ranks, 7 or over were deemed to be no commercial viability.

Absorption volume: The transferred liquid amount during 3 seconds measured according to “Measuring Method of Liquid Absorbability of Paper and Cardboard (Bristow method) defined by J. TPPI 51.

TABLE

| | Surface | | | | | |
|---|---|---|---|---|---|---|
| | condition | | Ink | Fissures | Ink | |
| | Smooth- | | absorb- | by | absorbing | |
| | ness | Cracks | ability | folding | volume | |
| Recording | A | 0 | 2 | A | 24.2 | Inv. |
| Paper 1 | | | | | | |
| Recording | A | 0 | 2 | A | 23.6 | Inv. |
| Paper 2 | | | | | | |
| Recording | A | 0 | 2 | A | 23.4 | Inv. |
| Paper 3 | | | | | | |
| Recording | B | 0 | 2 | A | 24.1 | Inv. |
| Paper 4 | | | | | | |
| Recording | B | 0 | 3 | A | 23.5 | Inv. |
| Paper 5 | | | | | | |
| Recording | B | 0 | 3 | A | 23.6 | Inv. |
| Paper 6 | | | | | | |
| Recording | A | 0 | 3 | A | 23.1 | Inv. |
| Paper 7 | | | | | | |
| Recording | B | 0 | 4 | A | 22.9 | Inv. |
| Paper 8 | | | | | | |
| Recording | A | 0 | 1 | A | 24.4 | Inv. |
| Paper 9 | | | | | | |
| Recording | A | 0 | 3 | B | 23.7 | Inv. |
| Paper 10 | | | | | | |
| Recording | A | 0 | 2 | B | 24.1 | Inv. |
| Paper 11 | | | | | | |
| Recording | A | 0 | 3 | B | 23.6 | Inv. |
| Paper 12 | | | | | | |
| Recording | A | 0 | 3 | A | 23.3 | Inv. |
| Paper 13 | | | | | | |
| Recording | A | 0 | 9 | A | 5.3 | Comp. |
| Paper 14 | | | | | | |
| Recording | C | 42 | 2 | E | 22.1 | Comp. |
| Paper 15 | | | | | | |
| Recording | A | 5 | 3 | E | 21.3 | Comp. |
| Paper 16 | | | | | | |
| Recording | E | 55 | 6 | E | 21.2 | Comp. |
| Paper 17 | | | | | | |
| Recording | E | 34 | 6 | B | 22.4 | Comp. |
| Paper 18 | | | | | | |
| Recording | D | 16 | 7 | B | 22.2 | Comp. |
| Paper 19 | | | | | | |

Inv.; Inventive
Comp.; Comparative

It was possible to prepare an ink jet recording sheet which resulted in high productivity, suffered negligibly from cracking during production and further exhibited high durability against folding and bending, a high void ratio, high ink absorbability. It was further possible to prepare an ink-jet recording sheet having high water resistance, and high bleeding resistance in addition to the above result.

1. An ink-jet recording sheet comprising;
a support; and a porous layer including fine particles and a binder containing a polymer compound crosslinked through side chains of the polymer on the support,
wherein the crosslinked polymer compound is formed the crosslink by irradiating ionizing radiation to a hydrophilic polymer compound which has a polymerization degree of not less than 300 and a plurality of side chains on a main chain of the hydrophilic polymer compound.

2. The ink jet recording sheet of claim 1, wherein a weight ratio of the fine particles to the binder in the porous layer is from 2:1 to 50:1.

3. The ink jet recording sheet of claim 1, wherein the weight ratio of the fine particles to the binder in the porous layer is from 6:1 to 15:1.

4. The ink jet recording sheet of claim 1, wherein the porous layer includes a multivalent metal compound.

5. The ink jet recording sheet of claim 1, wherein a diameter of fine particles is from 0.005 to 0.4 μm.

6. The ink-jet recording sheet of claim 1, wherein the hydrophilic polymer compound has a photosensitive group capable of dimerization by the ionizing radiation, on the side chains.

7. A producing method of an ink-jet recording sheet comprising steps of:
providing on a support a layer including fine particles and a binder containing hydrophilic polymer compound which has plural side chains on a main chain thereof and a polymerization degree of not less than 300; and
irradiating ionized radiation to the polymer compound to form crosslinking through the side chains to form a porous layer.

8. The producing method of an ink-jet recording sheet of claim 7, wherein a weight ratio of the fine particles to the binder containing the polymer compound formed by the crosslinking through the side chains is from 2:1 to 50:1.

9. The producing method of an ink-jet recording sheet of claim 7, wherein a weight ratio of the fine particles to the binder containing the polymer compound formed by the crosslinking through the side chains is from 6:1 to 15:1.

10. The producing method of an ink-jet recording sheet of claim 7, wherein the porous layer includes a multivalent metal compound.

11. The producing method of an ink-jet recording sheet of claim 7, wherein a diameter of the fine particles is from 0.005 μm to 0.4 μm.

12. The producing method of an ink-jet recording sheet of claim 7, wherein the hydrophilic polymer compound has a photosensitive group capable of dimerization by the ionizing radiation, on the side chains.

13. The producing method of an ink-jet recording sheet of claim 7, wherein the porous layer is formed by coating a coating composition comprising the fine particles and the hydrophilic polymer compound which has plural side chains on the main chain thereof and a polymerization degree of not less than 300, and irradiating an ionizing radiation to the polymer compound in the coated layer to form the crosslink between the side chains.

14. The producing method of an ink-jet recording sheet of claim 13, wherein the irradiation of the ionizing radiation is applied at a time in which the weight ratio of solvent to the solid component in the coated layer is not less than 100%.

15. The producing method of an ink-jet recording sheet of claim 13, wherein the polymer compound in the coated layer is irradiated the ionizing radiation so that the elastic modulus of the coated layer after the irradiation is not less than 1.5 times of that of the coated layer before the irradiation and the viscosity coefficient of the coated layer after the irradiation is not less than 1.5 times of that of the coated layer before the irradiation.

16. The producing method of an ink-jet recording sheet of claim 14, wherein the irradiation of the ionizing radiation is further applied at a time in which the weight ratio of solvent to the solid component in the coated layer is less than 100%.

17. The producing method of an ink-jet recording sheet of claim 13, wherein the coated layer is dried after the irradiation, in atmosphere at a temperature higher not less than 10° C. than before the irradiation.

18. The producing method of an ink-jet recording sheet of claim 13, wherein after the coated layer is dried, the coated layer is stood for not less than 24 hours in atmosphere at a temperature of not less than 30° C.

19. The producing method of an ink-jet recording sheet of claim 7, wherein the ionizing radiation is ultraviolet ray.
